(19) United States
(12) Patent Application Publication
(10) Pub. No.: US 2026/0075343 A1
(43) Pub. Date: Mar. 12, 2026

(54) CLUSTER-BASED DISTRIBUTED OPTICAL VIRTUAL-CIRCUIT-SWITCHING NETWORK SYSTEM

(71) Applicant: GeNopsys Technologies, Inc., Dover, DE (US)

(72) Inventors: Chi-Jui Maria YUANG, Hsinchu (TW); Shan ZHONG, Clarksville, MD (US); Po-Lung TIEN, Zhubei City (TW)

(21) Appl. No.: 19/324,450

(22) Filed: Sep. 10, 2025

Related U.S. Application Data
(60) Provisional application No. 63/693,602, filed on Sep. 11, 2024.

(51) Int. Cl. H04Q 11/00

(52) U.S. Cl. CPC H04Q 11/0005; H04Q 11/0071; H04Q 2011/0016; H04Q 2011/0039; H04Q 2011/006

(57) ABSTRACT

A cluster-based distributed optical virtual-circuit-switching network system comprises a tier-1 optical switching network and a tier-2 optical switching network. The tier-1 optical switching network includes a plurality of first-type optical switching network subsystems, each defining a cluster. The tier-2 optical switching network includes at least one second-type optical switching network subsystem, which comprises a plurality of tier-2 optical switches interconnected with one another. Each of the tier-2 optical switches correspondingly connects to one of the first-type optical switching network subsystems. When optical signals are transmitted between the clusters, the signals are transmitted from one of the first-type optical switching network subsystems to another through the tier-2 optical switches of the at least one second-type optical switching network subsystem.

### CROSS-REFERENCES TO RELATED APPLICATIONS

This application claims the benefit of U.S. Provisional Application Ser. No. 63/693,602 filed on Sep. 11, 2024. The entirety of the above application is incorporated herein by reference.

### BACKGROUND OF THE INVENTION

### Field of the Invention

The present invention relates to a cluster-based distributed optical virtual-circuit-switching network system, and more particularly, to a distributed optical virtual-circuit-switching network system having a two-tier architecture configured to provide efficient and flexible optical signal transmission between different clusters.

### Descriptions of the Related Art

High-performance computing (HPC) primarily relies on supercomputers or computing clusters to address large-scale and highly complex computational problems. Such problems typically involve massive data processing and intensive computational requirements, such as scientific simulations, climate modeling, and genomic analysis. With the explosive growth of data and the rising demand for computation, HPC systems require ever-increasing processing speeds and data transmission efficiency, as well as higher transmission rates and greater processing capacity. Against this backdrop, graphics processing units (GPUs), owing to their powerful parallel computing capabilities, have emerged as a core technology driving the advancement of HPC. In particular, in the field of artificial intelligence, GPUs accelerate neural network training and enabling machine learning models to process large and complex datasets more rapidly and accurately.

As the number of GPUs and the associated computational demands increase rapidly, the effective interconnection of large numbers of GPUs poses a significant challenge. This requires a network infrastructure capable of supporting ultra-high bandwidth, ultra-low latency, and large-scale data processing. In this context, optical virtual-circuit-switching network technology not only provides high-speed, low-latency data transmission, but also allows dynamic bandwidth allocation based on workload demands, thereby enabling collaborative processing among GPUs and further enhancing computational performance in HPC data centers.

Conventional optical virtual-circuit switching network systems generally adopt a single-tier network topology. In such architectures, as the number of GPU server racks increases, a proportional increase in optical switches is required, which in turn necessitates upgrades to their internal optical components to meet the bandwidth demands of large-scale GPU-to-GPU communication. However, scaling the optical components beyond a certain degree leads to a non-linear increase in manufacturing complexity and cost. Therefore, single-tier network topologies are suitable only for small- to medium-sized HPC data centers.

In view of the foregoing, existing technologies for large-scale HPC data centers still suffer from insufficient bandwidth and excessive optical switch manufacturing costs, problems that remain in need of improvement and resolution.

### SUMMARY OF THE INVENTION

An objective of the present invention is to provide a cluster-based distributed optical virtual-circuit-switching network system. The system is primarily characterized by a dual-tier architecture comprising a tier-1 optical switching network and a tier-2 optical switching network. The tier-1 optical switching network includes a plurality of first-type optical switching network subsystems, called clusters, while the tier-2 optical switching network includes at least one second-type optical switching network subsystem, which interconnects multiple clusters to form the overall two-tier optical switching network system. In the present invention, the topology of each first-type optical switching network subsystem (i.e., cluster) and second-type optical switching network subsystem is a known single-tier optical virtual-circuit-switching network. Optical signal transmission is carried out within each cluster of the tier-1 optical switching network, and also in the second-type optical switching network subsystem of the tier-2 optical switching network. Between the tier-1 and tier-2 optical switching network, optical-electrical-optical (O/E/O) conversion is carried out to enable wavelength reselection, thereby facilitating signal transmission across different clusters. The specifications and quantities of each first-type optical switching network subsystem, the second-type optical switching network subsystem, and all optical switches deployed in the system can be planned based on actual network bandwidth requirements. For example, when the system needs to be scaled out, the number of clusters can be increased while maintaining the size of each cluster. This approach allows the use of the same optical switch design, avoiding the need for higher-specification switches. The cluster-based system not only preserves key technical advantages—such as high flexibility, ultra-low latency, high bandwidth, and high efficiency—but also supports large-scale inter-cluster data transmission with reduced production costs and flexible routing options.

To achieve the above objective, the present invention discloses a cluster-based distributed optical virtual-circuit-switching network system for transmitting a plurality of optical signals. The cluster-based distributed optical virtual-circuit-switching network system comprises a tier-1 optical switching network and a tier-2 optical switching network. The tier-1 optical switching network includes a plurality of first-type optical switching network subsystems, each of which defines a cluster. The tier-2 optical switching network includes at least one second-type optical switching network subsystem. The at least one second-type optical switching network subsystem comprises a plurality of tier-2 optical switches interconnected with one another. Each of the tier-2 optical switches is connected to a respective one of the first-type optical switching network subsystems. When the optical signals are transmitted between the clusters, the optical signals are transmitted from one of the first-type optical switching network subsystems to another of the first-type optical switching network subsystems through the tier-2 optical switches of the at least one second-type optical switching network subsystem.

In one embodiment of the present invention, each of the first-type optical switching network subsystems comprises a plurality of tier-1 optical switches, at least one bridging optical switch, a plurality of local top-of-rack switches, and at least one bridging top-of-rack switch. The tier-1 optical switches are respectively connected to the local top-of-rack switches, the at least one bridging optical switch is correspondingly connected to the at least one bridging top-of-rack switch, and the tier-1 optical switches are interconnected with the at least one bridging optical switch so as to form the cluster.

In one embodiment of the present invention, each of the tier-2 optical switches is connected to a corresponding one of the at least one bridging top-of-rack switch, thereby enabling interconnection between the tier-1 optical switching network and the tier-2 optical switching network via the at least one bridging top-of-rack switch.

In one embodiment of the present invention, when the optical signals are transmitted within the same cluster, the optical signals are transmitted through the tier-1 optical switches within the same first-type optical switching network subsystem. When the optical signals are transmitted between different clusters, the optical signals are transmitted from one of the local top-of-rack switches of one first-type optical switching network subsystem to the corresponding tier-1 optical switch, then to the at least one bridging optical switch, and further through the corresponding at least one bridging top-of-rack switch and the tier-2 optical switch to one of the second-type optical switching network subsystems, and subsequently transmitted via another tier-2 optical switch of the at least one second-type optical switching network subsystem to another first-type optical switching network subsystem.

In one embodiment of the present invention, the at least one bridging top-of-rack switch comprises a plurality of wavelength-division multiplexing (WDM) transceivers. When the optical signals are transmitted between the clusters via the at least one bridging top-of-rack switch, the optical signals are subjected to optical-electrical-optical conversion by the wavelength-division multiplexing transceivers, thereby enabling wavelength selectivity of the optical signals.

In one embodiment of the present invention, the at least one second-type optical switching network subsystem consists of a plurality of second-type optical switching network subsystems, each of which is independent and not directly interconnected with one another.

In one embodiment of the present invention, the at least one bridging top-of-rack switch consists of a plurality of bridging top-of-rack switches. The at least one bridging optical switch consists of a plurality of bridging optical switches. Each of the second-type optical switching network subsystems is connected to a corresponding one of the bridging top-of-rack switches, enabling the optical signals to be selectively transmitted through different second-type optical switching network subsystems to different clusters.

In one embodiment of the present invention, the number of the first-type optical switching network subsystems is defined as M. Each of the first-type optical switching network subsystems comprises N tier-1 optical switches and N local top-of-rack switches, and further comprises K bridging optical switches and K bridging top-of-rack switches. The total number of optical switches within the tier-1 optical switching network is equal to (N+K)×M, that is, the product of the sum of N and K multiplied by M, where M, N, and K are positive integers.

In one embodiment of the present invention, the number of the at least one second-type optical switching network subsystem is also K, and the number of tier-2 optical switches is equal to M×K, that is, the product of M and K.

In one embodiment of the present invention, each of the first-type optical switching network subsystems is connected to a plurality of server racks through the corresponding local top-of-rack switches.

In one embodiment of the present invention, the tier-1 optical switches and the at least one bridging optical switch in each of the first-type optical switching network subsystems are interconnected with one another in a vertical and horizontal full-mesh topology via a plurality of optical fibers. The tier-2 optical switches in each of the at least one second-type optical switching network subsystem are likewise interconnected with one another in a vertical and horizontal full-mesh configuration via the optical fibers.

In one embodiment of the present invention, the tier-2 optical switches, the tier-1 optical switches, and the bridging optical switches have the same internal design. The local top-of-rack switches and the bridging top-of-rack switches have the same internal design. Furthermore, the network connectivity among the tier-1 optical switches in each of the first-type optical switching network subsystems is the same as the network connectivity among the tier-2 optical switches in each of the at least one second-type optical switching network subsystem.

The detailed technology and preferred embodiments of the present invention are described in the following paragraphs, accompanied by the appended drawings, to enable those skilled in the art to fully understand the objectives, technical methods, and embodiments of the claimed invention.

### BRIEF DESCRIPTION OF THE DRAWINGS

FIG. 1 is a schematic diagram illustrating the network connectivity in which a plurality of optical switches is arranged in a 5×5 single-tier network topology;

FIG. 2 is a schematic diagram illustrating the full-mesh topology in which each optical switch in the architecture of FIG. 1 is connected to other optical switches that are adjacent in both vertical and horizontal directions;

FIG. 3 is a schematic diagram illustrating an optical switching network subsystem in which each optical switch in the architecture of FIG. 1 is further connected to top-of-rack switches and server racks;

FIG. 4 is a schematic diagram illustrating the topology of a cluster-based distributed optical virtual-circuit-switching network system according to an embodiment of the present invention;

FIG. 5 is a schematic diagram illustrating two second-type optical switching network subsystems in the cluster-based distributed optical virtual-circuit-switching network system according to the embodiment of the present invention;

FIG. 6 is a partial schematic diagram of the cluster-based distributed optical virtual-circuit-switching network system according to the embodiment of the present invention;

FIG. 7 is a schematic diagram illustrating optical signal transmission between different first-type optical switching network subsystems in the cluster-based distributed optical virtual-circuit-switching network system according to the embodiment of the present invention; and

FIG. 8 is a schematic diagram illustrating the optical signal transmission routes between different first-type optical switching network subsystems in the embodiment of the present invention.

### DETAILED DESCRIPTION OF THE PREFERRED EMBODIMENT

The embodiments of the present invention will now be described in detail with reference to the accompanying drawings. These embodiments are provided for illustrative purposes only and are not intended to limit the present invention, its applications, or the particular implementations described herein. Wherever applicable, the same reference numbers are used in the drawings and description to denote the same or similar components. It should be noted that, in the following embodiments and attached drawings, elements unrelated to the present invention have been omitted for simplicity, and the dimensional relationships among elements in the drawings are depicted for clarity of understanding rather than to represent actual scale.

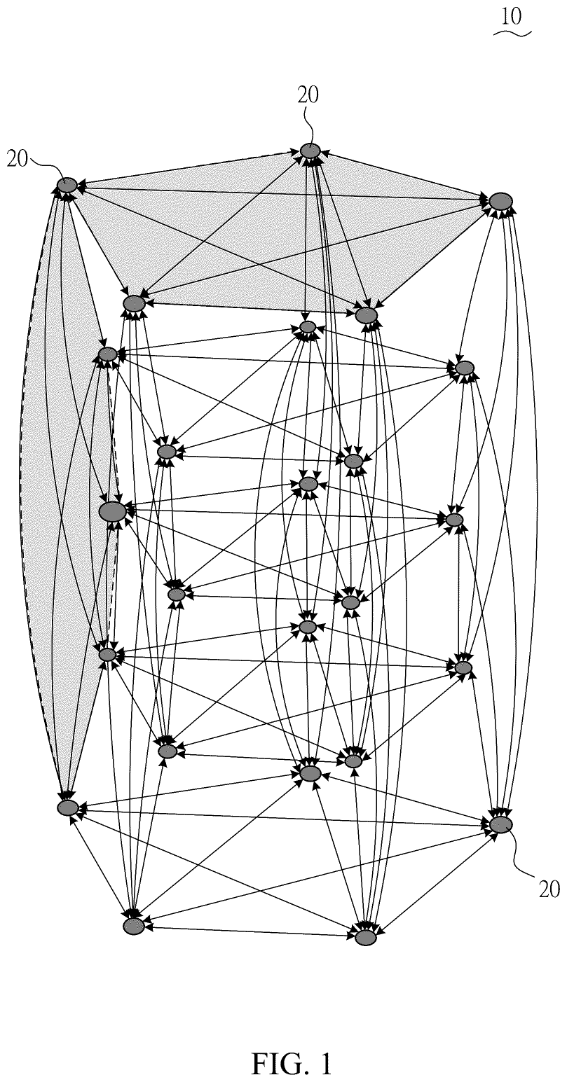

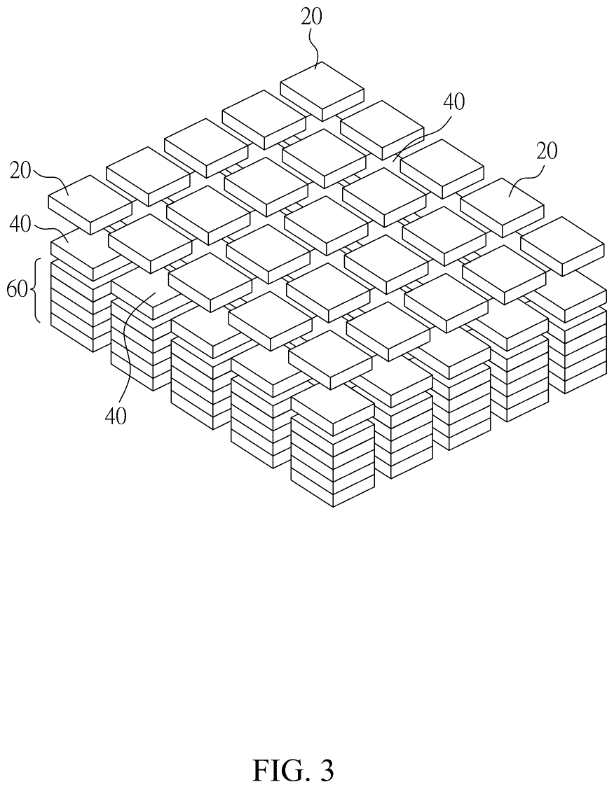

The concept of forming an optical switching network using multiple optical switches arranged in a single-tier network topology is described with reference to FIG. 1 to FIG. 3. Taking a 5×5 network architecture as an example, each optical switch 20 is connected in a full-mesh topology to vertically adjacent optical switches 20 via ribbon fibers. Similarly, each optical switch 20 is connected in a full-mesh topology to horizontally adjacent optical switches 20 via other ribbon fibers, thereby forming the optical switching network 10 with a single-tier network topology. Depending on the scale and transmission requirements of the system, the number of optical switches 20 in the single-tier topology may be adjusted, such as adopting a 4×4 or 3×3 network architecture. In addition, as shown in FIG. 3, the aforementioned optical switching network 10 is configured to support all-optical signal transmission, and each optical switch 20 is further connected to a top-of-rack (ToR) switch 40 and a server rack 60. The top-of-rack switch 40 converts electrical signals from the server rack 60 into optical signals via a wavelength-division multiplexing transceiver and transmits them to the optical switch 20, or converts optical signals from the optical switch 20 into electrical signals and transmits them to the server rack 60.

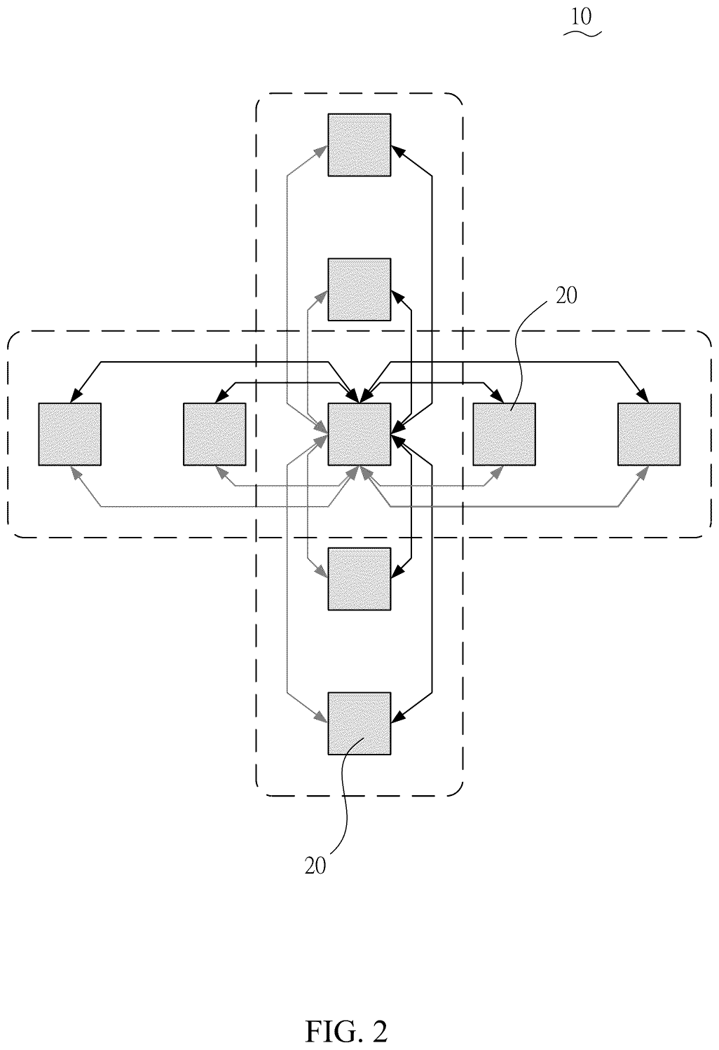

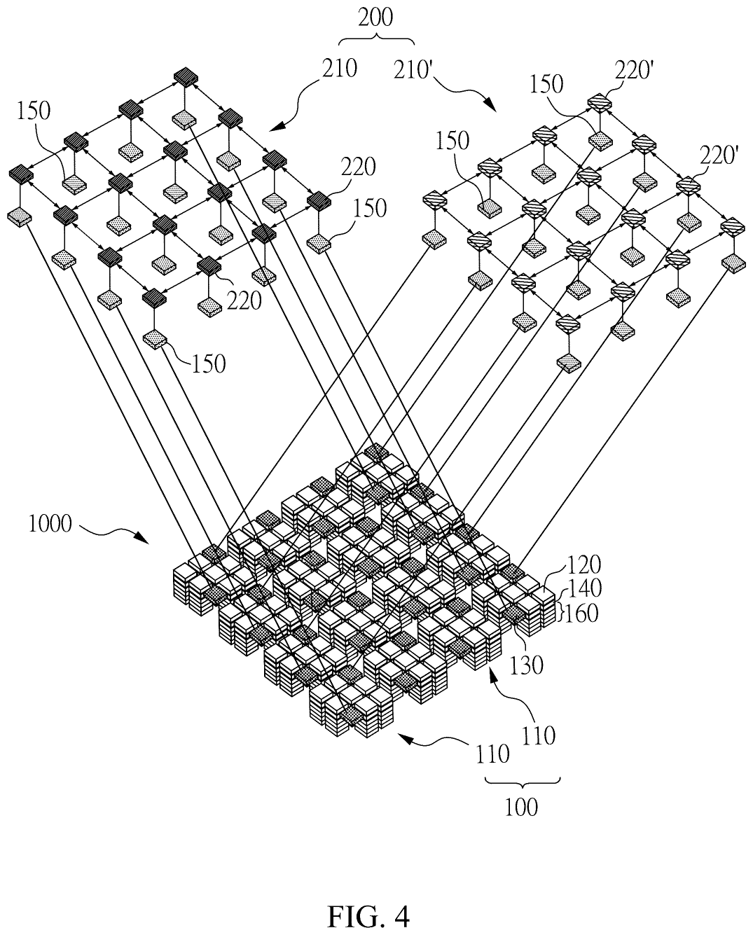

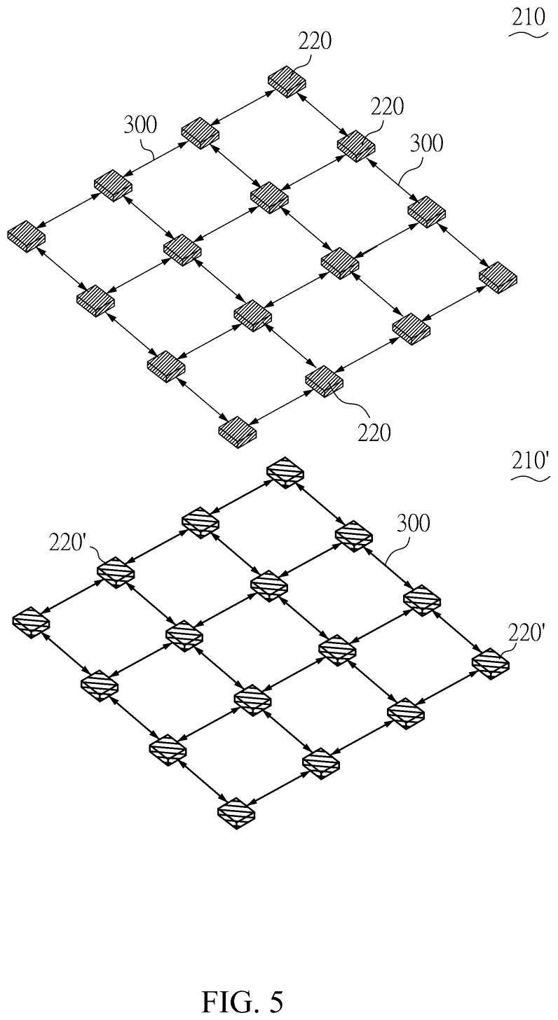

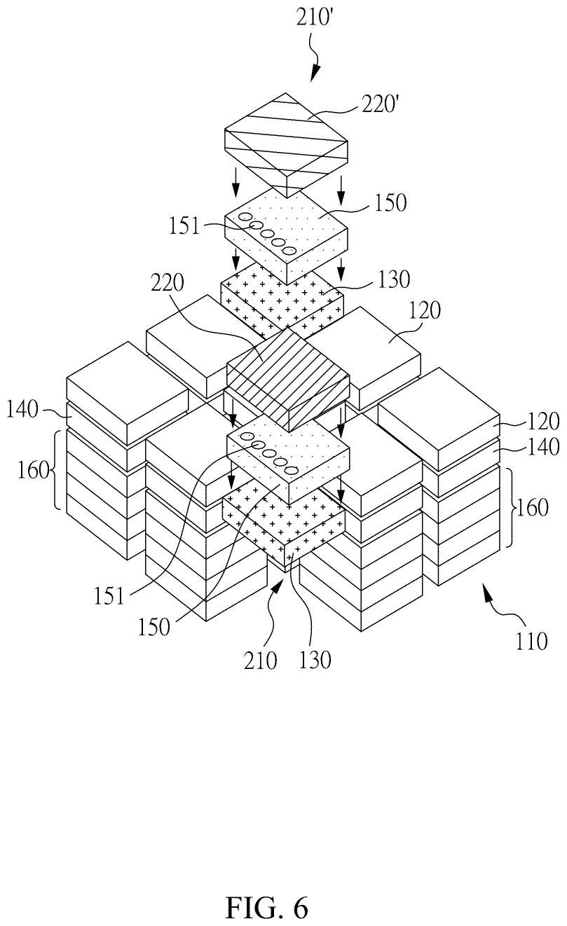

One of the key features of the present invention is the use of the above architecture and concept to construct a distributed optical virtual-circuit-switching network system 1000. As shown in FIG. 4, the cluster-based distributed optical virtual-circuit-switching network system 1000 comprises a tier-1 optical switching network 100 and a tier-2 optical switching network 200, each of which is a single-tier network topology, and collectively forming a two-tier network topology for transmitting optical signals. In the following embodiment, the tier-1 optical switching network 100 serves as the first-tier architecture and includes a plurality of first-type optical switching network subsystems 110. For example, the tier-1 optical switching network 100 comprises sixteen first-type optical switching network subsystems 110 (as shown in FIG. 4 and FIG. 6), each defined as a cluster and configured in a 3×3 topology, with all clusters sharing the same configuration. The tier-2 optical switching network 200, serving as the second-tier architecture, includes two independent second-type optical switching network subsystems 210 and 210′, which are connected to the first-type optical switching network subsystems 110 (as shown in FIG. 4 and FIG. 5). Each of the second-type optical switching network subsystems 210 and 210′ is composed of sixteen optical switches 220 and 220′ arranged in a 4×4 topology. Each optical switch 220 or 220′ corresponds to a respective first-type optical switching network subsystem 110, thus forming the distributed optical virtual-circuit-switching network system 1000 according to the embodiment of the present invention. It should be noted that the single-tier network topology of the optical switching network 10 illustrated in FIG. 1 and FIG. 2 is applicable to both the first-type optical switching network subsystems 110 and the second-type optical switching network subsystems 210. The optical switches used in both subsystems have the identical designs and specifications, and the interconnection methods among the optical switches are also the same.

It should be noted that, in the present embodiment, each of the first-type optical switching network subsystems 110 adopts a 3×3 interconnection topology. It will be appreciated that each first-type optical switching network subsystem 110 may alternatively adopt the 5×5 interconnection topology described in the previous embodiment (as shown in FIG. 1). However, for the purpose of clearly illustrating and explaining the system architecture in the figures, each first-type optical switching network subsystem 110 in this embodiment is described using a 3×3 interconnection topology, but is not limited thereto. Furthermore, FIG. 4 also shows that the tier-2 optical switching network 200 includes two independent and not directly interconnected second-type optical switching network subsystems 210 and 210′. However, it should be noted that this embodiment is not intended to limit the number of the second-type optical switching network subsystems. In fact, the present invention can be implemented with only one second-type optical switching network subsystem.

As shown in FIG. 6, in one embodiment of the present invention, each first-type optical switching network subsystem 110 further includes a plurality of tier-1 optical switches 120, at least one bridging optical switch 130, a plurality of local top-of-rack switches 140, and at least one bridging top-of-rack switch 150. It should be noted that, considering the need for wavelength matching in optical signal transmission and reception, the tier-1 optical switches 120 and the bridging optical switches 130 are optical switches of the same specification. When the external bandwidth requirement increases in the first-type optical switching network subsystem 110, the tier-1 optical switches 120 may be reconfigured to serve as the bridging optical switches 130, and the local top-of-rack switches 140 may be reconfigured to serve as the bridging top-of-rack switches 150. In this embodiment, each first-type optical switching network subsystem 110 adopts a 3×3 topology, wherein two of the tier-1 optical switches 120 are replaced with the bridging optical switches 130, and two of the local top-of-rack switches 140 are replaced with the bridging top-of-rack switches 150. However, the number and positions of these switches may be adjusted according to actual transmission requirements.

In one embodiment of the present invention illustrated in FIG. 5, the second-type optical switching network subsystem 210 comprises a plurality of the tier-2 optical switches 220 interconnected in a full-mesh topology in both vertical and horizontal directions. The tier-2 optical switches 220 adopt a 4×4 topology. Each tier-2 optical switch 220 is connected to a corresponding first-type optical switching network subsystem 110 to enable optical signal transmission between different clusters. Specifically, data transmission between different first-type optical switching network subsystems 110 must be routed through the at least one second-type optical switching network subsystem 210 of the tier-2 optical switching network 200. That is, the optical signals are transmitted from one of the first-type optical switching network subsystems 110 to another first-type optical switching network subsystem 110 through its corresponding connected tier-2 optical switch 220. When the optical signals are transmitted between different clusters, the optical signals are transmitted from one of the first-type optical switching network subsystems 110 and routed to another first-type optical switching network subsystem 110 via the tier-2 optical switch 220 of the at least one second-type optical switching network subsystem 210, thereby achieving efficient data transmission across clusters. As shown in FIG. 4, this embodiment illustrates two second-type optical switching network subsystems 210 and 210′ in the tier-2 optical switching network 200. The number of these subsystems can be selected based on the bandwidth requirements for optical signal transmission and is not limited thereto. In other feasible embodiments, two first-type optical switching network subsystems 110 and one second-type optical switching network subsystem 210 together form the minimum unit of a cluster-based distributed optical virtual-circuit-switching network system 1000 (not shown). Accordingly, the number of the second-type optical switching network subsystems can be flexibly adjusted to as few as one, depending on actual requirements. The number of the second-type optical switching network subsystems 210, 210′ in the tier-2 optical switching network 200 directly determines the number of the tier-2 optical switches 220, 220′ that need to be configured. The number of the second-type optical switching network subsystems 210, 210′ depends on the volume of data that the server racks 160 are required to transmit across the clusters. If the volume of data transmission across clusters (i.e., between different first-type optical switching network subsystems 110) is relatively small, fewer second-type optical switching network subsystems 210 may be adopted. Conversely, if the data volume across clusters is large, more second-type optical switching network subsystems 210 are required to meet the bandwidth demands. Specifically, at least one second-type optical switching network subsystem 210 is required to enable optical signal transmission between different clusters, and in this embodiment, two are provided as an illustrative example. Furthermore, increasing the number of the second-type optical switching network subsystems 210 enhances the overall network bandwidth and fault tolerance, while also offering greater flexibility in optical path selection to optimize transmission efficiency.

Specifically, as shown in FIG. 4 and FIG. 6, this embodiment shows the internal configuration and interconnections of each first-type optical switching network subsystem 110. Each tier-1 optical switch 120 is connected to a corresponding local top-of-rack switch 140. In this embodiment, each first-type optical switching network subsystem 110 is connected to a plurality of server racks 160 through its corresponding local top-of-rack switches 140. The at least one bridging optical switch 130 is correspondingly connected to the at least one bridging top-of-rack switch 150. Within the same cluster, the tier-1 optical switches 120 and the bridging optical switches 130 are interconnected in both horizontal and vertical directions in a full-mesh topology. This interconnection forms the first-type optical switching network subsystem 110, which defines a single cluster. On the other hand, as shown in FIG. 4, the tier-2 optical switches 220 are also interconnected in a full-mesh topology in both horizontal and vertical directions, and each tier-2 optical switch 220 is connected to a corresponding bridging top-of-rack switches 150. Similarly, each tier-2 optical switch 220′ is interconnected in a full-mesh topology in both horizontal and vertical directions, and is connected to a corresponding bridging top-of-rack switches 150. This configuration enables the tier-1 optical switching network 100 and the tier-2 optical switching network 200 to be interconnected through the bridging top-of-rack switches 150, thereby allowing the optical signals to be flexibly transmitted within the cluster-based distributed virtual circuit optical switching network system 1000.

It should be noted that, in this embodiment, as shown in FIG. 6, each of the first-type optical switching network subsystems 110 includes, for example, two bridging optical switches 130 and seven tier-1 optical switches 120, which constitute a 3×3 full-mesh topology in both vertical and horizontal directions. In this embodiment, the tier-2 optical switching network 200 includes two independent second-type optical switching network subsystems 210 and 210′. The tier-2 optical switches 220 and 220′ of the second-type optical switching network subsystems 210 and 210′ are respectively connected to the corresponding bridging optical switches 130 via their associated bridging top-of-rack switches 150. At the same time, each bridging optical switch 130 is also interconnected with the tier-1 optical switches 120 within the same cluster, collectively forming an optical signal transmission architecture that includes multiple first-type optical switching network subsystems 110 and two second-type optical switching network subsystems 210 and 210′. In addition, the local top-of-rack switches 140, which originally connected the server racks 160 to the tier-1 optical switches 120, are replaced with the bridging top-of-rack switches 150. These bridging top-of-rack switches 150 are correspondingly connected to the tier-2 optical switches 220, 220′ as well as to the bridging optical switches 130. It should be noted that, in this embodiment, the bridging top-of-rack switches 150 shown in FIG. 4 are not directly connected to the server racks 160. However, they may still connect to the server racks 160 through certain optical fiber ports, while the remaining ports are used to connect to the bridging optical switches 130. The connection between the bridging top-of-rack switches 150 and the server racks 160 is determined by actual optical transmission requirements and is not limited thereto.

It should be noted that the number of second-type optical switching network subsystems 210 and 210′ determines the quantity of the bridging optical switches 130 in each first-type optical switching network subsystem 110. Specifically, if the number of second-type optical switching network subsystems 210 and 210′ is configured as two, then each first-type optical switching network subsystem 110 correspondingly includes two bridging optical switches 130, with the number of bridging optical switches 130 being the same across all first-type optical switching network subsystems 110. Moreover, each second-type optical switching network subsystem 210 and 210′ is connected to the corresponding bridging top-of-rack switches 150 in each first-type optical switching network subsystem 110, allowing the optical signals to be selectively transmitted through different second-type optical switching network subsystems 210 and 210′ to reach different clusters. This configuration enables more flexible routing of the optical signals among multiple first-type optical switching network subsystems 110, thereby enhancing bandwidth utilization and routing flexibility within the overall network architecture.

In this embodiment, the tier-1 optical switches 120 and the at least one bridging optical switch 130 in each first-type optical switching network subsystem 110 are interconnected in a full-mesh topology in both vertical and horizontal directions via multiple optical fibers 300. Similarly, the tier-2 optical switches 220 and 220′ within each second-type optical switching network subsystem 210 and 210′ are also interconnected in a full-mesh topology through multiple optical fibers 300 in both vertical and horizontal directions. The optical signal transmission within the first-type optical switching network subsystems 110 and the second-type optical switching network subsystems 210 is realized by interconnecting the optical switches via the optical fibers. It should be noted that the network interconnection among the tier-1 optical switches 120 in the first-type optical switching network subsystem 110 may also differ from that among the tier-2 optical switches 220 in the at least one second-type optical switching network subsystem 210. The network interconnection can be adjusted based on actual network requirements and is not limited thereto.

In this embodiment, the optical signal transmission is dynamically selected and managed through the software control functions of software-defined networking (SDN), so as to optimize transmission efficiency. The SDN controller is configured to manage the optical signal transmission among the tier-1 optical switches 120, the bridging optical switches 130, the local top-of-rack switches 140, the bridging top-of-rack switches 150, and the tier-2 optical switches 220. Through real-time network status monitoring and resource allocation, the system enables adaptive optical routing and bandwidth provisioning, thereby improving overall optical transmission performance and resource efficiency.

In the following, the quantitative relationships among the components in the cluster-based distributed optical virtual-circuit-switching network system 1000 are described. In one example, the number of the first-type optical switching network subsystems 110 is defined as M, each first-type optical switching network subsystem 110 comprises N tier-1 optical switches 120 and N local top-of-rack switches 140. In addition, each first-type optical switching network subsystem 110 is configured with at least K bridging optical switches 130 and K bridging top-of-rack switches 150, where M, N, and K are positive integers. On the other hand, the number of the second-type optical switching network subsystems 210 is also K, and the total number of tier-2 optical switches 220 corresponds to the product of M and K. For example, in one embodiment (as shown in FIG. 4), the first-type optical switching network subsystem 110, configured as a cluster in the cluster-based distributed optical virtual-circuit-switching network system 1000, comprises seven tier-1 optical switches 120 and two bridging optical switches 130 (i.e., N=7, K=2). Accordingly, each first-type optical switching network subsystem 110 forms a 3×3 topology with a total of nine optical switches. In the same embodiment, the tier-1 optical switching network 100 of the cluster-based distributed optical virtual-circuit-switching network system 1000 is composed of four first-type optical switching network subsystems 110 arranged horizontally and four arranged vertically (i.e., M=16). It should be noted that this embodiment uses sixteen first-type optical switching network subsystems 110 as an example, whereas in practice the number of clusters can be adjusted according to different network topology designs and bandwidth requirements. A symmetric configuration with equal numbers in horizontal and vertical, such as 3×3, 4×4, or 5×5, can be adopted. Alternatively, an asymmetric configuration, such as 2×1, 3×2, or 5×4, may also be adopted to accommodate different network architecture requirements. The number and arrangement of the first-type optical switching network subsystems 110 can be adjusted based on actual bandwidth requirements, traffic distribution, and scalability needs, and are not limited thereto. Furthermore, the number of the local top-of-rack switches 140 corresponding to the tier-1 optical switches 120 is seven, while the number of the bridging top-of-rack switches 150 corresponding to the tier-2 optical switches 220 and the bridging optical switches 130 is two. On the other hand, the tier-2 optical switching network 200 includes two second-type optical switching network subsystems 210, and their number corresponds to the number of the bridging optical switches 130 configured in each first-type optical switching network subsystem 110. Since each first-type optical switching network subsystem 110 includes the same number of the bridging optical switches 130, the total number of the tier-2 optical switches 220 and 220′ is M×K=16×2=32. This architecture ensures the stability of network operation and enhances the transmission efficiency of the optical signals. In addition, in one embodiment of the present invention, as shown in FIG. 4, the total number of optical switches used in the cluster-based distributed optical virtual-circuit-switching network system 1000 is the sum of the optical switches in the tier-1 optical switching network 100, calculated as M×(N+K), and the optical switches in the tier-2 optical switching network 200, calculated as M×K. In this embodiment, the total number of optical switches configured in the cluster-based distributed optical virtual-circuit-switching network system 1000 is 176, and these optical switches may be implemented with a uniform specification to reduce construction costs.

As previously described, the present invention may also employ the first-type optical switching network subsystem 110 illustrated in FIG. 1 to FIG. 3, in which each first-type optical switching network subsystem 110 is configured in a 5×5 topology comprising a total of twenty-five optical switches. In practice, the number of optical switches in each first-type optical switching network subsystem 110 may be adjusted according to different transmission requirements, for example, it may be at least 2×2, 3×3, 4×4, or 5×5, and may further extend to 6×6, 7×7, or even larger configurations. The specific number can be optimally configured based on actual bandwidth requirements, topology design, and the scale of the optical switches, and is not limited thereto.

In one embodiment of the present invention, the tier-2 optical switches 220, the tier-1 optical switches 120, and the bridging optical switches 130 share the same internal design and specifications. In practical applications, it is assumed that all optical switches are designed to comply with the 5×5 topology of the first-type optical switching network subsystem 110. That is, each optical switch is capable of being connected to four other optical switches in both the horizontal and vertical directions (as shown in FIG. 1 and FIG. 2), and the internal configuration of the wavelength selective switches (WSS) within each optical switch also corresponds to the 5×5 topology. Furthermore, in this embodiment, when each optical switch is designed according to the aforementioned specifications, the first-type optical switching network subsystem 110 may be configured in a 5×5 topology, in which up to twenty-five optical switches (i.e., 5×5) can be deployed in each first-type optical switching network subsystem 110. However, smaller scale configurations such as 4×4 or 3×3 are also applicable. Similarly, the optical switches in the second-type optical switching network subsystem 210 also conform to the 5×5 topology, and may be adapted to other network configurations of different scales, such as 4×4 or 3×3. The unified internal specifications of the optical switches enhance system adaptability, allowing for flexible deployment based on actual application requirements, thereby improving overall operational efficiency and scalability while reducing construction costs.

However, in other embodiments of the present invention, the tier-2 optical switches 220, tier-1 optical switches 120, and the bridging optical switches 130 may adopt different internal designs, provided that the wavelengths for optical signal transmission and reception remain compatible. The local top-of-rack switches 140 and the bridging top-of-rack switches 150 may also adopt different internal designs. The internal designs of the optical switches and the top-of-rack switches can be optimized according to actual data transmission requirements to meet the demands of different network topologies and traffic management, and are not limited thereto. However, it is understood that employing the optical switches and the top-of-rack switches of the same specifications facilitates cost reduction in system construction, and thus represents a preferred embodiment.

Next, the optical signal transmission process is described in detail. When the optical signals are transmitted within the same cluster, the optical signals are transmitted through the tier-1 optical switches 120 within the same first-type optical switching network subsystem 110. When the optical signal are transmitted between different clusters, as shown in FIG. 6 to FIG. 8, the optical signal are first transmitted from one of the local top-of-rack switches 140 of the first-type optical switching network subsystem 110 to its corresponding tier-1 optical switch 120, and then forwarded to the at least one bridging optical switch 130. The optical signals are subsequently transmitted through the corresponding at least one bridging top-of-rack switch 150 and the tier-2 optical switch 220 to the at least one second-type optical switching network subsystem 210. Thereafter, the optical signals are further transmitted via another tier-2 optical switch 220 of the second-type optical switching network subsystem 210 to another first-type optical switching network subsystem 110.

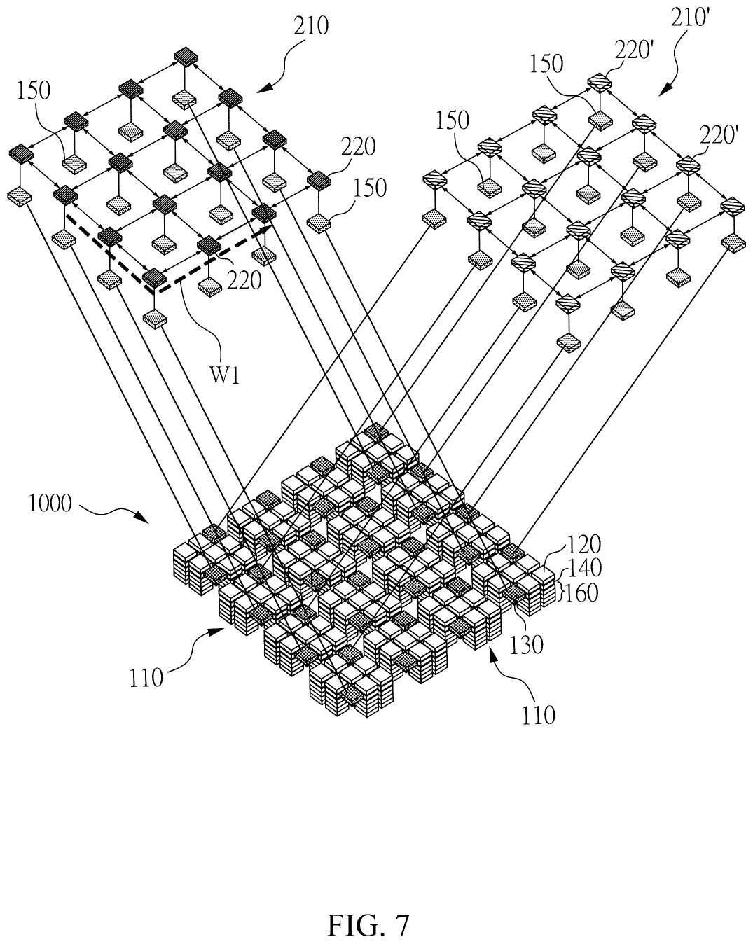

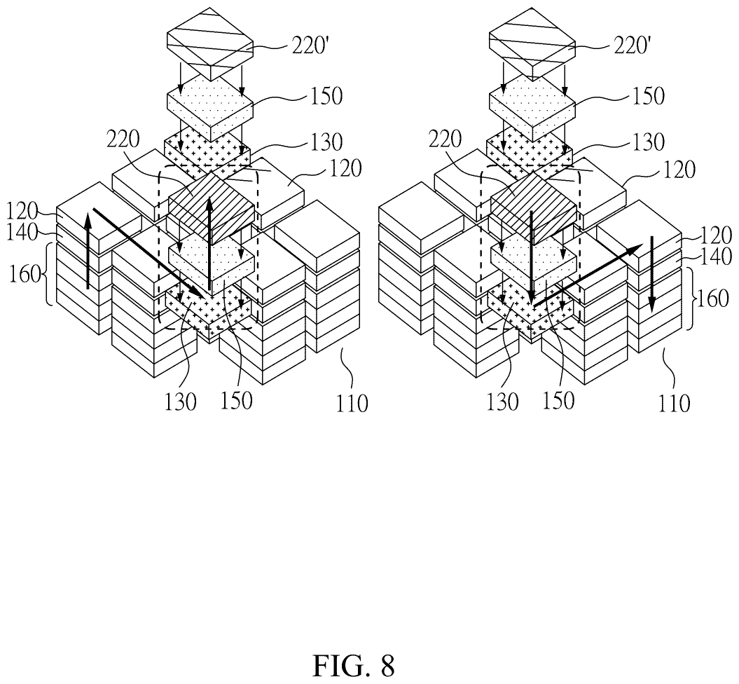

Referring to FIG. 7 and FIG. 8, when the server rack 160 serving as a source server transmits data to another server rack 160 serving as a destination server, the transmission path follows the direction indicated by arrow W1 in FIG. 7. The transmission steps are described as follows.
Step 1: As shown in the left diagram of FIG. 8, the source server rack 160 transmits data to the tier-1 optical switch 120 of the first-type optical switching network subsystem 110 via its corresponding local top-of-rack switch 140, where the data is converted into the optical signals and uploaded. The optical signals are then transmitted to the bridging optical switch 130 of the first-type optical switching network subsystem 110, and further transmitted via the correspondingly connected bridging top-of-rack switch 150 to the tier-2 optical switch 220 of the associated second-type optical switching network subsystem 210. It should be noted that the bridging optical switch 130 of the first-type optical switching network subsystem 110 is capable of receiving the optical signals transmitted from any server rack 160 within the same first-type optical switching network subsystem 110, and primarily facilitates the forwarding of the optical signals between different first-type optical switching network subsystems 110 through the bridging optical switch 130 and the second-type optical switching network subsystem 210.
Step 2: The tier-2 optical switch 220 transmits the optical signals through the second-type optical switching network subsystem 210 to another tier-2 optical switch 220 corresponding to a different first-type optical switching network subsystem 110, as shown in FIG. 7.
Step 3: As shown in the right diagram of FIG. 8, another tier-2 optical switch 220 corresponding to a different first-type optical switching network subsystem 110 transmits the optical signals via the bridging top-of-rack switch 150 to the bridging optical switch 130 of the first-type optical switching network subsystem 110. The bridging optical switch 130 then transmits the optical signals to the tier-1 optical switch 120 corresponding to the destination server rack 160 within the first-type optical switching network subsystem 110, which ultimately delivers the data through the local top-of-rack switch 140 to the destination server rack 160, thereby completing the data transmission.

Next, the optical signal transmission between the first-type optical switching network subsystem 110 and the second-type optical switching network subsystem 210 is described in detail. As shown in FIG. 6, each bridging top-of-rack switch 150 includes a plurality of wavelength-division multiplexing transceivers 151 configured to connect the bridging optical switch 130 and the corresponding tier-2 optical switch 220. Since the bridging top-of-rack switch 150 functions as an electrical switch, when the optical signals are transmitted through the bridging top-of-rack switch 150 between clusters, the optical signals undergo optical-electrical-optical (OEO) conversion via the wavelength-division multiplexing transceivers 151, enabling wavelength re-selection of the optical signals. Specifically, when the optical signals are transmitted from the bridging optical switch 130 to the bridging top-of-rack switch 150, the wavelength-division multiplexing transceiver 151 converts the optical signals into the electrical signals. Subsequently, when the electrical signals are to be forwarded to the tier-2 optical switch 220, the wavelength-division multiplexing transceiver 151 converts the electrical signals back into the optical signals. This OEO conversion process allows dynamic wavelength selection of the optical signals. For example, when the optical signals are transmitted at wavelength λ1 from the bridging optical switch 130 of the first-type optical switching network subsystem 110 to the bridging top-of-rack switch 150, after OEO conversion, the optical signals entering the tier-2 optical switch 220 may be converted into wavelength λ2 and transmitted as optical signals of a different wavelength to another first-type optical switching network subsystem 110. Through this mechanism, dynamic wavelength adjustment for the transmission of the optical signals across clusters not only enhances spectral efficiency, but also increases the number of available optical paths, thereby further optimizing overall resource allocation.

In summary, the cluster-based distributed optical virtual-circuit-switching network system proposed herein includes multiple first-type optical switching network subsystems, each defined as a cluster. Each cluster comprises multiple optical switches interconnected in a full-mesh topology in both horizontal and vertical directions, including the tier-1 optical switches and the bridging optical switches. Each cluster further comprises the local top-of-rack switches connected to the server racks and the bridging top-of-rack switches connected to the second-type optical switching network subsystem. Unlike prior art, the present invention introduces at least one second-type optical switching network subsystem comprising multiple tier-2 optical switches. The tier-2 optical switches in each second-type optical switching network subsystem correspond to and are connected with different first-type optical switching network subsystems. Optical signals are transmitted from the tier-1 optical switches of the first-type optical switching network subsystem to the bridging optical switches, then via the bridging top-of-rack switches to the tier-2 optical switches of the second-type optical switching network subsystem, and through optical signal transmission to another tier-2 optical switch, which finally delivers the optical signals to another first-type optical switching network subsystem.

Through the novel two-tier optical switching network subsystem topology, efficient data transmission between server racks across different clusters is achieved. Further, the second-type optical switching network subsystem responsible for optical signal transmission between different clusters may be designed with an appropriate number of the tier-2 optical switches and the second-type optical switching network subsystem according to traffic demands. The independent second-type optical switching network subsystems not only provide multiple optical path options but also enhance system flexibility and reliability, while the uniform specification of the optical switches reduces construction costs. Moreover, the bridging top-of-rack switch enables optical-electrical signal conversion and wavelength re-selection, further enhancing network applicability and scalability. This stacked optical switching network subsystem architecture supports cross-cluster data transmission and offers efficient, reliable optical network services, especially suitable for large-scale data transmission, low-latency, and high-bandwidth, such as AI data centers and cloud computing infrastructures.

Although the present invention has been described in considerable detail with reference to certain embodiments thereof, other embodiments are possible. Therefore, the spirit and scope of the appended claims should not be limited to the description of the embodiments contained herein.

What is claimed is:

1. A cluster-based distributed optical virtual-circuit-switching network system for transmitting a plurality of optical signals, comprising:
a tier-1 optical switching network including a plurality of first-type optical switching network subsystems, each of the first-type optical switching network subsystems defining a cluster; and
a tier-2 optical switching network including at least one second-type optical switching network subsystem, the at least one second-type optical switching network subsystem comprising a plurality of tier-2 optical switches that are interconnected with one another, each of the tier-2 optical switches being connected to a respective one of the first-type optical switching network subsystems;
wherein, when the optical signals are transmitted between the clusters, the optical signals are transmitted from one of the first-type optical switching network subsystems, through the tier-2 optical switches of the at least one second-type optical switching network subsystem, to another one of the first-type optical switching network subsystems.

2. The cluster-based distributed optical virtual-circuit-switching network system of claim 1, wherein each of the first-type optical switching network subsystems comprises a plurality of tier-1 optical switches, at least one bridging optical switch, a plurality of local top-of-rack switches, and at least one bridging top-of-rack switch, wherein the tier-1 optical switches are respectively connected to the local top-of-rack switches, the at least one bridging optical switch is correspondingly connected to the at least one bridging top-of-rack switch, and the tier-1 optical switches and the at least one bridging optical switch are interconnected with one another so as to form the cluster.

3. The cluster-based distributed optical virtual-circuit-switching network system of claim 2, wherein each of the tier-2 optical switches is respectively interconnected with a corresponding one of the at least one bridging top-of-rack switch, thereby interconnecting the tier-1 optical switching network and the tier-2 optical switching network via the at least one bridging top-of-rack switch.

4. The cluster-based distributed optical virtual-circuit-switching network system of claim 3, wherein when the optical signals are transmitted within the same cluster, the optical signals are transmitted through the tier-1 optical switches within the same first-type optical switching network subsystem, and when the optical signals are transmitted between different clusters, the optical signals are transmitted from one of the local top-of-rack switches of the first-type optical switching network subsystem to the corresponding tier-1 optical switch, then to the at least one bridging optical switch, and further through the corresponding bridging top-of-rack switch and the tier-2 optical switch to the at least one second-type optical switching network subsystems, and thereafter via another tier-2 optical switch of the at least one second-type optical switching network subsystem to another first-type optical switching network subsystem.

5. The cluster-based distributed optical virtual-circuit-switching network system of claim 4, wherein the at least one bridging top-of-rack switch comprises a plurality of wavelength-division multiplexing transceivers, and when the optical signals are transmitted between the clusters via the at least one bridging top-of-rack switch, the wavelength-division multiplexing transceivers perform optical-electrical-optical conversion, thereby enabling wavelengths of the optical signals to be selectable.

6. The cluster-based distributed optical virtual-circuit-switching network system of claim 3, wherein the at least one second-type optical switching network subsystem consists of a plurality of second-type optical switching network subsystems that are independent from one another and not directly interconnected.

7. The cluster-based distributed optical virtual-circuit-switching network system of claim 6, wherein the at least one bridging top-of-rack switch consists of a plurality of bridging top-of-rack switches, the at least one bridging optical switch consists of a plurality of bridging optical switches, and each of the second-type optical switching network subsystems is connected to a respective one of the bridging top-of-rack switches, thereby enabling the optical signals to be selectively transmitted through different second-type optical switching network subsystems to different clusters.

8. The cluster-based distributed optical virtual-circuit-switching network system of claim 3, wherein the number of the first-type optical switching network subsystems is defined as M, each of the first-type optical switching network subsystems comprises N tier-1 optical switches and N local top-of-rack switches, and further comprises K bridging optical switches and K bridging top-of-rack switches, wherein the total number of optical switches within the tier-1 optical switching network is (N+K)×M, where M, N, and K are positive integers.

9. The cluster-based distributed optical virtual-circuit-switching network system of claim 8, wherein the number of the at least one second-type optical switching network subsystem is K, and the number of tier-2 optical switches is M×K.

10. The cluster-based distributed optical virtual-circuit-switching network system of claim 3, wherein each of the first-type optical switching network subsystems is connected to a plurality of server racks via the respective local top-of-rack switches.

11. The cluster-based distributed optical virtual-circuit-switching network system of claim 2, wherein the tier-1 optical switches and the at least one bridging optical switch in each of the first-type optical switching network subsystems are interconnected with one another in both vertical and horizontal directions in a full-mesh topology via a plurality of optical fibers, and the tier-2 optical switches in each of the at least one second-type optical switching network subsystem are likewise interconnected with one another in both vertical and horizontal directions in a full-mesh topology via a plurality of optical fibers.

12. The cluster-based distributed optical virtual-circuit-switching network system of claim 2, wherein the tier-2 optical switches, the tier-1 optical switches, and the bridging optical switches have the same internal design, the local top-of-rack switches and the bridging top-of-rack switches have the same internal design, and the network interconnection among the tier-1 optical switches in each of the first-type optical switching network subsystems is the same as the network interconnection among the tier-2 optical switches in each of the at least one second-type optical switching network subsystems.
